(19) United States
(12) Patent Application Publication
(10) Pub. No.: US 2025/0362970 A1
(43) Pub. Date: Nov. 27, 2025

(54) ADAPTIVE PROVISIONING OF CLOUD VOLUMES

(71) Applicant: INTERNATIONAL BUSINESS MACHINES CORPORATION, Armonk, NY (US)

(72) Inventors: Subramaniyan Nallasivam, Bangalore (IN); Peng Hui Jiang, Beijing (CN); Dileep Dixith, Hyderabad (IN); Abhiram Kulkarni, Bengaluru (IN); Varchaswini R, Bangalore (IN)

(21) Appl. No.: 18/671,596

(22) Filed: May 22, 2024

(51) Int. Cl. G06F 9/50

(52) U.S. Cl. CPC G06F 9/505; G06F 9/5044; G06F 9/5083

(57) ABSTRACT

Adaptive provisioning of cloud storage volumes includes building a vector database having properties of storage devices of a cloud environment, associating storage devices with storage classes based on the properties of the storage devices, each storage device of the storage devices being associated with a storage class of the storage classes, receiving a request for provisioning a storage volume to support a workload, where the request indicates application requirements associated with servicing the workload, performing a semantic search on the vector database and determining, based on the semantic search, a storage class for the requested storage volume, and provisioning the storage volume on a storage device, of the storage devices, associated with the determined storage class.

### BACKGROUND

The present invention relates to provisioning cloud resources, and more specifically to adaptive provisioning of storage volumes to storage devices.

### SUMMARY

Shortcomings of the prior art are overcome and additional advantages are provided through the provision of a computer-implemented method. The method builds a vector database having properties of storage devices of a cloud environment. The method additionally associates the storage devices with storage classes using the properties of the storage devices. Each storage device of the storage devices is associated with a storage class of the storage classes. The method also receives a request for provisioning a storage volume to support a workload. The request indicates application requirements associated with servicing the workload. Further, the method performs a semantic search on the vector database and determines, based on the semantic search, a storage class for the requested storage volume. The method additionally provisions the storage volume on a storage device, of the storage devices, associated with the determined storage class for the requested storage volume.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual diagram of an environment in which storage volume requests are received and processed;

FIG. 3 depicts an example conceptual diagram of an adaptive provisioning method and architecture, in accordance with aspects described herein;

FIG. 4 depicts further details of example adaptive provisioning code to incorporate and/or use aspects described herein; and

FIG. 5 depicts an example process for adaptive provisioning of storage volumes, in accordance with aspects described herein.

### DETAILED DESCRIPTION

Described herein approaches for adaptive provisioning of cloud storage volumes. In some environments providing cloud resources including processing facilities and cloud storage, for instance a Kubernetes cluster orchestration environment (KUBERNETES is a registered trademark of The Linux Foundation, San Francisco, California), there is a volume provision controller service (vprcs) and a volume placement controller services (vplcs) of the cloud storage platform. The vprcs determines the storage nodes and/or storage devices thereof on which to provision requested storage volumes, and the vplcs provisions virtual images (as the storage volumes on storage devices) to the Kubernetes cluster as persistent volumes. The vplcs might, as an example, use a round-robin approach for storage volume placement within cloud storage, without taking into account complexities such as network resources in selecting where to provision requested storage volumes. This can result in sub-optimal storage volume placement within the storage nodes of the cloud storage. Also, the approach presents challenges with respect to performance and other storage provisioning issues because load may not be equally or desirably balanced among the various storage nodes of the storage node clusters (also referred to as simply “storage cluster”). In general, there are deficiencies in existing cloud volume provisioning approaches, and these deficiencies result in inefficiencies across clustered cloud storage environments.

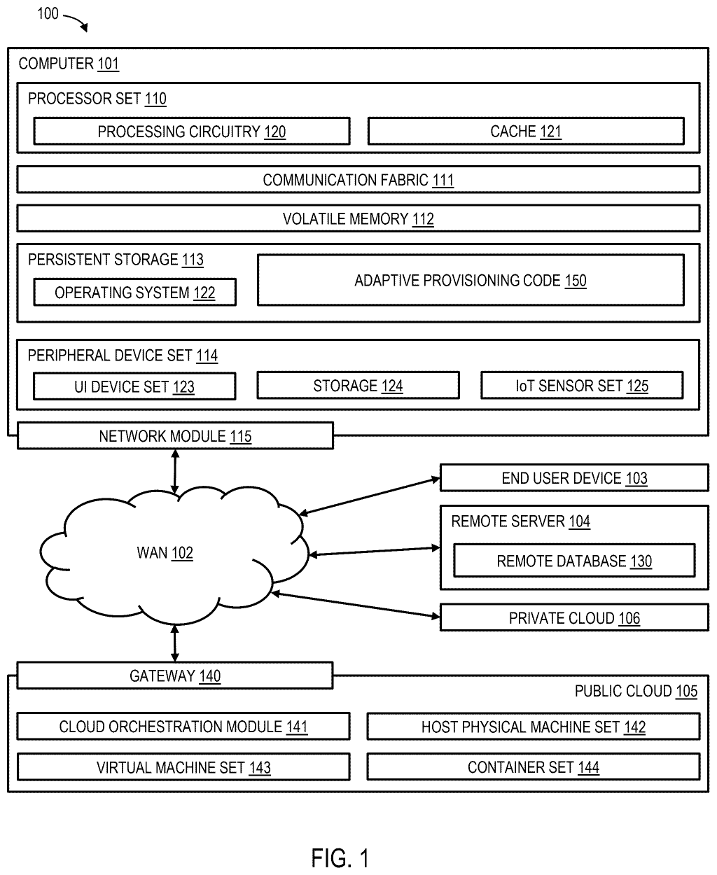

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptive provisioning code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

A common scenario for cloud storage volume provisioning in a cloud environment is as follows. A user, client, or other entity will request one or more virtual server instances (VSI) be provisioned in a virtual private cloud (VPC) environment, such as one providing a cluster of computing resources. Provisioned VSI(s) will have attached data storage volumes for storing data in whatever form desired, for instance as a database. The storage volume(s) for a VSI are realized on one or more storage devices of storage nodes, for instance storage nodes in a clustered storage environment of the cloud environment. Different storage devices will yield different performance and other characteristics for different workloads and workload types (interchangeably referred to herein as application types). Therefore, provisioned storage volumes can differ in terms of the characteristics (such as size, speed, and performance in terms of performing read and write operations (i.c., input/output operations, also referred to as IOPS), bandwidth, latency and other characteristics) provided by the storage devices on which the volumes are provisioned. In addition, a request to provision a volume might have a regional layer/component to it; determining an optimal or desired location for placing the new storage volume and provisioning the volume to the VSI may be important because application performance is determined in part by network and storage resources. Example of such network resources include the switch network and any other connectivity facilities between the involved storage resources. Example storage resources include the various storage clusters, the different storage nodes connected within those storage clusters, and the storage devices of/attached to those storage nodes.

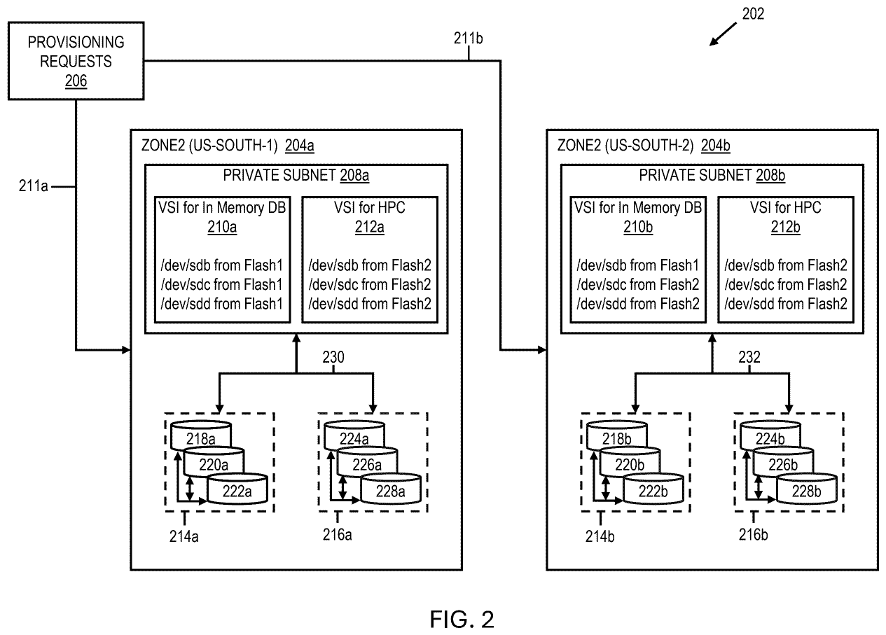

FIG. 2 depicts an example conceptual diagram of an environment in which storage volume requests are received and handled. Environment 202 is, or is part of, a cloud environment. Shown are two sites 204a, 204b of the cloud environment. These sites could correspond to different geographical and/or regional sites that are remote from each other, and include different sets of computing resources (which may or may not be of the same/similar types as each other in terms of the types of their hardware and software).

Requests for storage volume provisioning are directed to these sites for fulfillment. Specifically, when client provisioning requests 206 to provision storage volumes are made, they are provided to the vpres (not pictured). The requests to provision volumes could be made through a REST (representational state transfer) application programming interface (API) layer or through another tool enabling cloud infrastructure automation and management, as examples, and could be made in the form of, or in conjunction with, requests to provision VSIs. In any case, the requests are to provide storage volumes for VSIs, for instance VSIs 210a, 212a, 210b, and 212b, on private subnets 208a, 208b accessed via floating IP messages 211a, 211b. In this example, private subnet 208a has VSI 210a provisioned for an in memory database workload supported by three storage volumes—/dev/sdb,/dev/sdc, and/dev/sdd—all of a first type of flash storage (Flash 1), and has VSI 212a provisioned for a high-performance computing application/workload supported by three storage volume—/dev/sdb,/dev/sdc, and/dev/sdd—all of a second type of flash storage (Flash 2). The act of provisioning the storage volumes on storage devices selects the storage device(s) to use from the available storage resources.

More specifically, the storage resources backing these two VSIs and their provisioned volumes are provided by heterogeneous storage node clusters 214a, 216a. In site 204a, there are two software-defined storage node clusters 214a and 216a. Storage node cluster 214a includes storage nodes 218a, 220a, 222a, each having a respective one or more storage devices of the first type of flash storage, and therefore cluster 214a supports VSI 210a because the three provisioned storage volumes are provisioned to storage devices of node(s) of cluster 214a. Storage node cluster 216a includes storage nodes 224a, 226a, 228a, each having a respective one or more storage devices of the second type of flash storage, and therefore cluster 214a supports VSI 212a because the three provisioned storage volumes are provisioned to storage devices of node(s) of cluster 216a. Thus, different storage devices could be of different types, for instance different types of flash storage in this example. Here, storage devices of nodes 218a, 220a, and 222a are of the first type of flash storage, and storage devices of nodes 224a, 226a, and 228a are of the second type of flash storage. Communication between private subnet 208a and storage node clusters 214a, 216a occurs over communications links 230, which may be any type of wired and/or wireless communications links.

At site 204b, private subnet 208b has VSI 210b provisioned for a mixed high-performance computing and low latency application/workload supported by one volume (/dev/sdb) of the first flash storage type and two volumes (/dev/sdc,/dev/sdd) of the second flash storage type, and has VSI 212b provisioned for a relatively high IOPS application/workload supported by three volumes of the second flash storage type—/dev/sdb,/dev/sdc,/dev/sdd). The storage resources backing these VSIs and their provisioned volumes are also provided by heterogeneous storage node clusters in site 204b, specifically software-defined storage node clusters 214b and 216b. In this example, storage node cluster 214b includes storage nodes 218b, 220b, and 222b, each having a respective one or more storage devices of the first flash storage type, and storage node cluster 216b includes storage nodes 224b, 226b, and 228b, each having a respective one or more storage devices of the second flash storage type. The actual storage volumes provisioned to any given VSI could be provided by any one or more of the storage node clusters, nodes, and/or devices. In the case of VSI 210b, two volumes are provided by storage device(s) of storage node(s) of storage node cluster 216b providing flash storage of the second type, and one volume is provided by storage device(s) of storage node(s) of storage node cluster 214b providing flash storage of the first type. Communication between private subnet 208b and storage node clusters 214b, 216b occurs over communications links 232, which may be any type of wired and/or wireless communications links.

A create volume request, for instance of a provisioning request 206, could be part of a request package that includes and/or is indicative of required, desired, and/or anticipated performance-related characteristics, for example amounts, magnitudes, or other characteristics of volume capacity, volume IOPS, volume throughput, and latency, as examples. The vpres could receive the request package and send this to the vplcs, which is to determine the storage node(s) on which to provision the requested volume(s), i.c., provision the desired storage volume(s), create the storage volume(s) on storage device(s) of the storage node(s), and send a response to the client.

Different workloads/applications can be expected to have different requirements as it relates to use of storage resources by way of their provisioned storage volumes. An in-memory database might require relatively low latency at relatively low input/output depth (referring to the number of pending I/O requests that a storage resource can handle at any one time). For that type of workload, a storage volume could be placed and provisioned from a first storage class, for instance one corresponding to a first type of storage (for example a first type of flash memory). In contrast, a high-performance computing workload might require a relatively high bandwidth configuration and relatively high IOPS handling in order to perform as desired. For that type of workload, a storage volume could be placed and provisioned from a second storage class, for instance one corresponding to a second type of storage (for example a second type of flash memory different from the first type of flash memory). However, current approaches for storage node selection and creation of storage volumes on selected storage nodes having storage devices of a given storage type use approaches relying on round-robin or weighted mechanisms for storage node selection and storage volume creation/placement. These approaches are error-prone and inefficient, as application requirements can go unsatisfied. For instance, an application requiring relatively low latency and high bandwidth might experience higher latency and lower bandwidth than tolerable on account that it was placed in a round-robin fashion on a node with storage devices that do not provide low enough latency and high enough bandwidth. In turn, this could cause problems when performing IO operations, leading to undesired user experiences. Even in more advanced provisioning approaches, metrics like latency, bandwidth, read/write operations per second (IOPS), and others are not taken into consideration when provisioning storage volumes to storage devices. Furthermore, basic keyword or metric-based searching to identify storage devices to which to provision storage volumes may not be sufficient to capture the context and nuances of the workload and requirements for its data and performance.

In order to satisfactorily meet demand from clients, customers, or other entities, provided herein are approaches enabling cloud administrators to dynamically provision storage volumes and attach those to virtual server instances. Challenges arise in how to best provision storage volumes for workloads/applications while delivering on user requirements. Aspects described herein help to determine these best matches of storage devices and storage volume placement thereon to satisfy storage volume provisioning requests based on application requirements.

In accordance with aspects described herein, a vector database is defined and created to hold properties, such as historical data, pertaining to the performance of storage devices in a collection of storage devices, for instance data embodying metrics such as read/write operations per second, bandwidth, latency, and response times of the storage devices, as examples. A vector database in this context refers to a database and system designed to efficiently store and manage vectors (vector-based data). A vector in this context represents a set of values or features (for instance in the form of numerical data) that describes individual or aggregated properties or characteristics of an object or entity, or group of objects/entities. The historical data pertaining to a storage device can be reflective of a storage class and corresponding label for that device. Classes may be identified, and storage devices may be associated with these (i.e., classified in one of the storage classes) based on their historical performance in supporting workloads of one or more types. An incoming storage volume provisioning request can indicate application requirements—requirements relative to a workload to be supported by the storage volume—and these application requirements can inform a feature vector that can be compared to vectors of the vector database. For example, the application requirements can used to build search criteria, for instance as a feature vector from featurizing the application requirements, and define a search, for example a semantic search, that searches the vector database based on that search criteria. A result of the semantic search may be a list of vectors, storage class(es) suggested by those vectors, and/or and corresponding storage device(s) exhibiting the features of those vectors. The list could rank these results by their semantic similarity to the search criteria.

A semantic search of a vector database refers to the retrieval of results based on the meaning or ‘semantic similarity’ of the search criteria. This is contrast to a query using just raw numerical values, for example. A semantic search allows a search for information using, as examples, natural language queries or by providing example vectors that represent the desired concept or meaning to be searched-for in the database.

In accordance with aspects described herein, a process can analyze historical performance data of storage devices, for instance data about read/write operations per second data, bandwidth, latency of the storage devices and usage of volume for different workloads, and train a historical storage access model on these inputs to featurize the inputs. The features can be embedded in vector form indicative of different storage classes and store these to a vector database. Then, when placing requested storage volumes on storage devices, a process can take a provisioning request as input can determine a best storage class to satisfy that request. In this manner, the process can identify a storage class (and a particular storage device in that class) to use based on the application requirements as ascertained from the provisioning request.

In some embodiments, a model or process is used to perform a label/class matching that identifies, based on the historical data reflected by the vectors in the vector database, whether there is an exact match between a class reflected in the vector database one what is reflected by the application requirements of the request. A semantic search or other type of search may be effective in identifying whether there is an exact match. In any event, in the case of an exact match between a class and the requirements, the storage volume can be provided by a storage device of that particular storage class. In some examples, the granularity of the storage class may be as fine as a specific storage device. In other examples, storage classes have multiple storage devices associated with them on account that the historical performance metrics of those storage metrics for a given workload type are sufficiently the same or similar that they are classified in the same storage class. In the event of no exact match, then the storage class that most closely matches to the requirements can be selected. In this regard, semantic searching could be used to search the vector database and return a list of vectors (or storage classes indicated by them), and this optionally could be ranked by semantic similarity to the search criteria.

Thus, in naive implementations of storage volume provisioning, the provisioning might rely solely on a round-robin or static rule mechanism without considering historical metrics. For example, volume provisioning might be based on a straightforward rotation through storage resources without taking into account factors such as performance, availability, or cost. In contrast, and in accordance with aspects described herein, a data-driven approach is taken in which historical metrics related to performance, availability, and/or cost (as examples) are considered during the provisioning decision-making process. Semantic searching based on a vector database can help identify storage classes that match, or at least are more semantically similar to, the specific application requirements, including those of performance, availability, and/or cost considerations, of provisioning requests, which helps better align the provisioning of storage resources with the workloads they are to support. Accordingly, in one aspect, semantic searching is provided based on historical metrics (c.g., performance, availability, cost) to identify storage classes that best match the application requirements of a conveyed provisioning requests. The data-driven approach can take into account historical metrics of performance, available, and/or cost per unit for the represented storage classes. It can ensure that storage volumes are provisioned on storage devices of storage classes that have demonstrated high availability (for example), potentially reducing downtime. Additionally, it can consider cost implications, leading to more cost-effective provisioning based on current pricing models, for instance.

Further details are now provided using specific examples. A volume placement controller service (or other process) will determine from logs or other records various properties of storage devices, for instance properties concerning storage access (read/write operations) relative to dynamic and/or static requests from applications of various workloads and various workload types. The process determines properties such as response times and other behavior in servicing those requests across particular time interval(s), storage device read/write operations per second (IOPS) ratios, random/sequential accesses of the storage devices, latency and bandwidth, and any other properties and of the performance of the storage devices. This may result in the building of features that are embedded in vector form and store this information in a vector database. The vectors can inform different storage classes, the classes differing in terms of the performance and other characteristics of the storage device(s) fitting into those classes. Label(s) may be created to define these storage classes and corresponding/associated storage devices.

By way of example, the following presents two example storage class entities (A and B) with different performance indicators. Storage class entity A may include indicators:
Application name: Database
Network latency.: 10 ms
Number of read: 10000 IOPS
Number of write: 20000 IOPS
Bandwidth: 4 mbps

Storage class entity B may include indicators:
Application name: Database
Network latency.: 0.5 ms
Number of read: 15000 IOPS
Number of write: 30000 IOPS
Bandwidth: 10 mbps

It is seen that different performance indicators are reflected as between the two different storage classes. These features can be embedded into vectors corresponding to the classes, the vectors stored into a database. Example resulting vectors used to build such a vector database from the above two examples are as follows:
Storage class entity A Vector: [1, 10, 10K, 20K, 4]
Storage class entity B Vector: [2, 0.5,15K, 30K, 10]

There could be any number of storage classes reflected. Additionally, there could be a 1-to-1 correspondence between the storage classes and the vectors of the database (meaning each storage class could be defined by just one vector), though this is not a requirement. For instance, two or more vectors that are stored might be sufficiently similar that they reflect a same storage class. This might be common at the inception of the vector database. Over time, there might be some aggregation actions that occur to aggregate vectors that are sufficiently similar to be reflective of a same storage class, and it may be the case that each storage class will correspond to one vector in the vector database.

In this regard, for one or more of the storage classes, threshold value(s) can be defined for one or more of the metrics, such as read/write operation per second (IOPS), response times, latency, bandwidth and/or others. The thresholds can be used to define the scopes of the storage classes. In some examples, the vectors could build-in these thresholds, for instance by providing ranges in one or more vector dimensions, such as a range of [0.4,0.6] representative of a range in network latency (in milliseconds) provided by storage devices of the storage class.

Thus, the vples or other component could, before placing a storage volume to a particular storage class/device, perform (or invoke a component to perform) a semantic search on the vector database. The semantic search helps in defining a context of the storage volume requested for use relative to the historical metrics from the vector database, for instance storage device read/write operations per second (IOPS) ratio, random/sequential access of the storage device, latency, response time, and bandwidth, as examples. As an example sequence, a request for provisioning a storage volume for attaching to a virtual server instance or other virtual entity is received and indicates application requirement(s). In examples, these are indicated through metadata specifying, as examples, the workload, workload type, and/or specific properties related to performance, availability, and/or cost of the desired storage volume. These requirements may be used to construct search criteria—in one example, a vector—and a semantic search is performed of the vector database. A storage class is determined based on this search criteria.

If a storage class matching the criteria is found, the volume placement controller service (or other process) can provision the storage volume from storage device(s) associated with that particular storage class. ‘Matching’ in this context can mean that all or a threshold minimum number of the applications requirements are satisfied by the storage class. In the case of no exact match, then based on the semantic search a list of storage classes and/or storage devices of those classes is provided. The list may reflect a rank of those results by their semantic similarity. In any case, a storage class is selected/determined, and the storage volume is provisioned to a storage device the selected storage class.

In this manner, workloads can be provided storage volumes that are provisioned to storage classes/devices that have historically performed in a manner consistent with what the workload requires as reflected by the application requirement indicated by the provisioning request. A workload requiring relatively low latency at lower I/O depth is appropriately provisioned volume(s) from a first storage class, while another workload requiring a relatively high bandwidth configuration and IOPS performance is appropriately provisioned volume(s) from a second storage class.

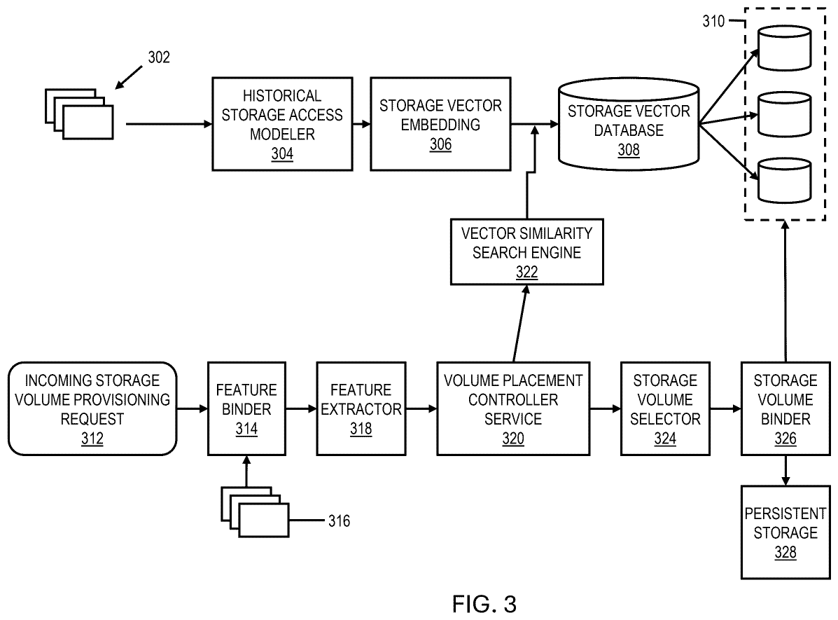

FIG. 3 depicts an example conceptual diagram of an adaptive provisioning method and architecture, in accordance with aspects described herein. Metrics regarding storage accesses by a collection 302 of workloads/applications are provided to a historical storage access modeler 304. The modeler 304 is responsible for extracting the most relevant features of the incoming data, for instance based on identified successes and failures related to storage accesses. The modeler 304 outputs to storage vector embedding component 306 that embeds the features in any appropriate or desired format-in this case as built vectors with various dimensions. The embedding maps different feature values into different vector entries, as incoming data may be in different formats, units, or the like. The built vectors are then stored to the storage vector database 308. The vectors can represent storage classes to with storage devices 310 are associated based on their performance.

Incoming storage volume provisioning requests 312 are received and include input that can be parsed and interpreted to search against the vector database 308. A request will indicate application requirements. In examples, the request indicated a workload/workload type to which the request pertains. Additionally or alternatively, it can explicitly include application requirements (in the form of performance indicated) such as those discussed herein. The request (or indicated application requirements) are provided to a feature binder component 314, which facilitates the establishment of relationships between the requirements of the incoming storage provision requests and corresponding storage features for associated workloads (for instance features as identified by the storage access modeling and embedded in vector form to the vector database). In other words, the feature binder 314 builds relationships between the requirements of the request and the features that are provided in the vector database.

Additionally, current workload properties 316 may be considered to better reflect a multi-tenant scenario where various workloads coexist within a same cloud environment, as current workloads could affect performance of the storage nodes and therefore impact other workloads. This acknowledges that a diverse set of concurrent workloads running in the system could be relevant for effective provisioning. As an example specific approach for current workload consideration, take a situation in which a set of hits (hitl to hitM) are obtained from the current storage provisioning requests against the vector database and simultaneously there is another set of hits (hitX to hitZ) derived from the current workload against the same vector database. Overlap Analysis with Confidence scoring may be applied, in which a process assesses the overlap between the two sets (hitl to hitM) and (hitX to hitZ) to identify potential matches that align with both existing workloads and new provisioning requests. The process can introduce confidence scores to adjust the significance of the overlap. Higher confidence scores may indicate a stronger suitability for a match, for instance. The process can also adjust confidence scores to refine them based on the degree of overlap between the current workload hits and the vector database hits, or adjust the scores to reflect the relevance of cach hit in accommodating both the current storage provisioning requests and the ongoing workload, for instance. Additionally, iterative searching against the vector database can utilize the current workload hits (hitX to hitZ) to iteratively search against the historical database. This search may yield multiple hits, and confidence scores can help prioritize and refine the selection of the most appropriate matches. In this manner, a process can correlate the hits from current storage requests with stored vector database hits to derive the confidence levels and attempt to adjust accordingly if there is overlap between the hits from current storage requests and the stored vector database hits. Also, iterative searching can help in prioritizing the selection of most appropriate matches when multiple hits are returned.

Continuing with FIG. 3, current workload properties 316 may therefore additionally be provided to the feature binder. Feature extractor 318 leverages the output from the feature binder 314, for instance relationships between features of the vectors in the database and the requirements (potentially influenced by current workload 316) for the workload to which the provisioning request pertains, extract the pertinent features reflected by the requirements. This enhances the system's ability to understand and respond to specific application requirements.

The following presents a collection of examples of incoming storage provision requests 312 and the operation of the binder 314 and extractor 318 on them to identify features and extract them. Each example presents an example workload (database of a particular type, transaction workload, etc.).
a) One instance of a JSON (JavaScript Object Notation) document database—Feature Extraction Example:
Feature 1: Database Size—Extraction Method: Query for a representative size (e.g., typical, average, median, etc.) of instances of databases of this type
Feature 2: Read/Write Throughput—Extraction Method: Assess the historical read and write operations per second from instances of databases of this type
Feature 3: Database Workload Type—Extraction Method: Analyze the workload type (e.g., transactional or analytical, as examples) of instances of databases of this type
b. Incoming Storage Provision Request: One Online Transaction Processing (OLTP) transaction—Feature Extraction Example:
Feature 1: Transaction Rate—Extraction Method: Capture the rate of same/similar OLTP transactions
Feature 2: Latency Requirements—Extraction Method: Extract desired latency constraints (e.g., specified in the OLTP transaction request)
Feature 3: Indexing Patterns—Extraction Method: Analyze indexing patterns of the OLTP transaction for storage optimization
c. Incoming Storage Provision Request: One Online Analytical Processing (OLAP) transaction—Feature Extraction Example:
Feature 1: Query Complexity—Extraction Method: Evaluate the complexity of same/similar OLAP queries to determine storage needs
Feature 2: Aggregate Function Usage—Extraction Method: Identify the types and frequency of aggregate functions used in OLAP transactions
Feature 3: Data Size for Analysis—Extraction Method: Assess the size of data required for analytical processing
d. Incoming Storage Provision Request: One Cloud Object Storage (COS) instance request—Feature Extraction Example:
Feature 1: Object Storage Size—Extraction Method: Retrieve information on the size of objects stored within same/similar COS instances
Feature 2: Access Patterns—Extraction Method: Analyze historical access patterns to understand how frequently, and in what manner, objects are accessed
Feature 3: Data Lifecycle—Extraction Method: Evaluate the lifecycle of data within same/similar COS instances, considering archival or frequently accessed data
e. Incoming Storage Provision Request: Machine Learning Model Storage—Feature Extraction Example:
Feature 1: Model Size—Extraction Method: Retrieve an actual or anticipated size of this or other machine learning models to determine storage requirements
Feature 2: Inference Rate—Extraction Method: Analyze the rate at which same/similar models (or this model is anticipated to) make predictions for inference workloads
Feature 3: Training Data Size—Extraction Method: Assess the size of the training dataset used for model training same/similar models (or this model)
f. Incoming Storage Provision Request: Content Delivery Network (CDN) Cache—Feature Extraction Example:
Feature 1: Cached Content Size—Extraction Method: Determine the size of content cached in same/similar CDNs for faster retrieval
Feature 2: Content Popularity—Extraction Method: Analyze historical access patterns to identify popular content for caching
Feature 3: Cache Hit Rate—Extraction Method: Calculate the rate at which requested content is served from same/similar CDN caches
g. Incoming Storage Provision Request: Database Backup Storage—Feature Extraction Example:

Feature 1: Backup Frequency—Extraction Method: Analyze how frequently database backups are performed

Feature 2: Backup Size—Extraction Method: Retrieve the size of database backups to estimate storage needs

Feature 3: Retention Policy—Extraction Method: Assess the duration for which backup data needs to be retained
h. Incoming Storage Provision Request: Video Streaming Storage—Feature Extraction Example:
Feature 1: Video Resolution and Quality—Extraction Method: Retrieve information on the resolution and quality of the streaming videos
Feature 2: Streaming Bitrate—Extraction Method: Analyze the bitrate of video streams for optimal storage provisioning
Feature 3: Viewership Patterns—Extraction Method: Understand historical viewership patterns to allocate storage based on demand peaks

Continuing with FIG. 3, the vplcs 320 uses the feature extraction results of feature extractor 318 and invokes a vector similarity search against database 308 using vector similarity search engine 322. In an example, features extracted by 318 are built into a vector format (or other search criteria), and the search engine 322 performs a semantic search. Ultimately, the results are provided to storage volume selector 324 to select/determine a storage class associated storage devices(s) for the requested storage volume. The storage volume binder 326 binds the storage volume as persistent storage/volume 328 of the VSI (or other entity to which the volume is provisioned) to appropriate storage device(s) of collection 310.

The introduction of the storage volume selector component 324 addresses the challenge of choosing the most suitable storage device from multiple candidate storage devices 310. This decision-making process may be performed by considering both the incoming storage provision request 312 and the contextual information provided by the current workload 316. The selector component 324 aims to optimize storage selection based on a holistic understanding of the system's requirements.

The following depicts two example structures, e.g., vectors, providing properties of storage devices. Different storage devices might have different properties for different applications or types of applications, resulting in different built vectors. The vectors can be provided in the vector database in this format or in any desired data structure format.

```
{
  “vector”: [
    1, // Application Identifier
    10, // Network Latency (ms)
    10000, // Number of Read Operations per Second (IOPS)
    20000, // Number of Write Operations per Second (IOPS)
    4, // Bandwidth (Mbps)
    0.5, // Response Time (seconds)
    150, // Storage Capacity in gigabytes (GB)
    7200, // Mean Time Between Failures (MTBF) in hours
    3, // Storage Class Tier (e.g., 1 for high-performance, 2 for
  standard, 3 for archival)
    0.8 // Storage Reliability Score (normalized, ranging from 0 to 1)
    0.05 // Cost per GB (normalized, ranging from 0 to 1)
  ]
}
storage_characteristics_input = {
  ‘application_id’: 4,
  ‘network_latency’: 18.0,
  ‘read_iops’: 18000,
  ‘write_iops’: 27000,
  ‘bandwidth’: 7.2,
  ‘response_time’: 0.6,
  ‘storage_capacity’: 300,
  ‘mtbf’: 10000,
  ‘storage_class_tier’: 2, # Standard
  ‘reliability_score’: 0.80,
  ‘cost_per_gb’: 0.08,
  ‘power_consumption’: 120, # Sustainability consideration
  ‘encryption_support’: True # Security consideration
}
```

Application Identifier (‘application_id’) represents an identifier for a specific application associated with a storage device. It might indicate a given type of database. Each application could have a different application identifier.

Network Latency (‘network_latency’) represents the network latency associated with the storage device (measured in milliseconds, for example).

Number of Read Operations per Second (Read IOPS) (‘read_iops’) indicates the number of read operations the storage device can perform per second.

Number of Write Operations per Second (Write IOPS) (‘write_iops’) indicates the number of write operations the storage device can perform per second.

Bandwidth (‘bandwidth’) represents the bandwidth of the storage device measured in, e.g., megabits per second.

Response Time (‘response_time’) reflects the response time of the storage device, e.g., in seconds. This provides insights into the speed at which the device responds to requests.

Storage Capacity (‘storage_capacity’) indicates the total storage capacity of the device, e.g., in GB. It considers the volume of data the storage device can accommodate.

Mean Time Between Failures (MTBF) (‘mtbf’) reflects the expected duration between failures for the storage device, measured in, e.g., hours. A higher MTBF suggests greater reliability.

Storage Class Tier (‘storage_class_tier’) assigns a tier value to the storage class, allowing differentiation based on performance levels. An example tier system could be 1 for high-performance, 2 for standard, or 3 for archival.

Storage Reliability Score (‘reliability_score’) represents a normalized reliability score, e.g., ranging from 0 to 1. It provides an overall measure of the reliability of the storage device.

Cost per GB (‘cost_per_GB’) represents the cost per GB of storage, e.g., ranging from 0 to 1. It provides a quantitative measure of an economic aspect, allowing for a balanced assessment of both performance and cost metrics.

Power Consumption (‘power_consumption’) reflects the power consumption of the storage device in a desired unit, and may be considered to account for sustainability metrics.

Encryption Support (‘encryption_support’) indicates whether the storage device supports encryption, and may be considered to account for security capabilities.

The above properties, particularly network_latency, IOPS (read and write), bandwidth, and response_time, reflect storage system pressure in terms of device performance.

Each vector could be specific to a combination of workload/application type and storage device characteristic(s) for a storage class. One type of flash storage may be expected to be a different storage class than another type of flash storage because the storage devices of those different flash storage types might exhibit different characteristics of performance, reliability, etc. The class/characteristics may be embedded in the vector data in the form of storage class tier, reliability score, and other information, as an example. Multiple available storage devices could fit into a same storage class as long as their properties are sufficiently similar. Thus, in some embodiments, a group of candidate storage devices could be identified from one or more vectors as storage devices all fitting within a common (one) storage class. Additionally or alternatively, identifiers of the individual storage devices could be stored as part of the vector data if desired.

If a given workload type is run on different types/classes of storage device, then this could result in two (or more) vectors corresponding to two (or more) different storage classes. And, as noted previously, if instances of the same workload type are used with devices of the same type/class, this could result in multiple vectors corresponding to the one workload/device type combination, or a single vector for the aggregate properties of that workload/device type combination.

With the building and maintaining of the vector database, a process can query the database to identify storage devices that meet specific criteria ascertained from a provisioning request. For example, the process can identify devices with a response time below a certain threshold and/or with a cost per GB within a specified range, as examples. Searches can be performed to identify devices satisfying any one or more criteria. Furthermore, when satisfying a storage volume provisioning request, the vector database can be queried using a semantic search approach, which involves identifying storage devices described by vectors that are semantically similar to the desired characteristics for the new storage volume. The similarity can be determined based on a distance metric or similarity measure, as examples.

For instance, one approach uses an embedding-based semantic search to calculate a cosine of an angle between two vectors. For any given comparison, the vector representing the desired characteristics for the new storage volume is compared to a vector in the vector database. The closer the cosine value is to 1, the more similar the vectors are. This approach includes representing storage vectors as embeddings in a continuous vector space, where semantically-similar vectors are closer to each other. In this manner, the semantic search includes an embedding-based semantic search that represents vectors of the vector database as embeddings in a continuous vector space, and performing the semantic search identifies one or more vectors, of the vector database, embedded in the continuous vector space nearest a vector built based on the indicated application requirements.

Another example approach uses a graph-based semantic search to build a graph in which each node represents a storage vector, and edges connect nodes that are among the k-nearest neighbors based on some selected/set distance metric. This approach builds a graph representation of the storage vectors, where nodes represent storage vectors, and edges represent semantic relationships. In this manner, the semantic search can include a graph-based semantic search that builds a graph with nodes representing vectors of the vector database and edges connecting nodes that are among k-nearest neighbors based on a distance metric, and performing the semantic search identifies one or more nodes, of the graph, with edges connecting to a node, of the graph, built based on the indicated application requirements. This identifies nodes, and therefore vectors which, in turn, identify specific storage devices, most closely fitting the requirements.

The semantic search can return a given set of storage classes and/or specific devices of those classes, and the results may be ranked in order of semantic similarity to the query vector. Further filtering could be performed on the results if desired. List(s) of matching storage classes/devices could be provided for different sets of criteria, if desired. As noted, thresholds could be put in place to help define the meaning of certain criteria. For instance, a criterion (application requirement) of ‘standard availability storage’ could be defined by thresholds on the MTBF storage device property, for example a threshold minimum MTBF (and optionally a maximum threshold MTBF). Devices outside of this range could be considered to fall within a higher or lower availability tier (and different storage class), for instance.

For some searches, potentially multiple different candidate allocations can be generated. In order to narrow these down, a user could, for instance, increase a confidence index or other similar threshold to use for the similarity comparison, which could result in fewer candidate storage devices satisfying the criteria.

Additionally or alternatively, current workload of the devices could be more heavily considered or weighted as part of the similarity comparison. The current storage workload can significantly impact storage placement decisions, dynamically allocating resources based on real-time demands, performance requirements, and/or cost considerations. For example, high-performance applications may trigger provisioning from optimized storage classes, while cost-sensitive workloads can prioritize economical options while meeting performance thresholds. The real-time nature of the workload ensures adaptive resource allocation to meet specific criteria.

To maintain the relevance and effectiveness of the historical storage access modeler (304), updates may be made when there are substantial enough shifts in workload characteristics, new workloads are introduced, or adjustments in the storage infrastructure occur, as examples. Changed cost structures, pricing models, and resource availability can inform model adjustments as well. In general, proactive periodic retraining, feedback mechanisms, and responsiveness to deviations in performance or cost can help keep the model finely tuned to evolving storage dynamics. Model adaptation to changes in the storage workload yields benefits such as optimized resource utilization, improved cost-efficiency, and enhanced responsiveness to business needs. The model's dynamic allocation of storage resources aligns with real-time workload demands, ensuring applications receive necessary performance characteristics without compromising cost-effectiveness. This adaptive approach allows organizations to stay agile amid changing storage requirements, aligning provisioning decisions with evolving business and technological landscapes.

In this manner, the vector database may be maintained by, in part, performing a refresh/retraining of the modeler (e.g., 304) used in building the vector database to provide adaptive provisioning of cloud storage volumes, where the refresh may be based on
changes in characteristics of workloads supported by the storage devices, the characteristics including types or number of applications, usage patterns, and/or performance requirements;
changes in storage infrastructure, the changes in storage infrastructure including introduction of a new storage class, removal of storage class of the storage classes, and/or changes in network configuration of the cloud environment; and/or
regular time updates where, as a proactive measure to ensure that the models remain relevant and effective over time, lapse of a time interval for updating the vector database triggers the updating.

Properties of storage devices (and therefore the training data for the modeler) can go beyond raw performance-oriented metrics, extending to, as examples, availability, price, durability, and others. For instance, the properties data can also include availability and reliability metrics, price and cost metrics, durability and reliability, environmental impact, and sustainability metrics. Others are possible.

Availability and reliability metrics can include, as examples (i) Uptime/downtime—Track the historical availability of storage devices or storage classes. Include metrics related to uptime and downtime; and (ii) Fault tolerance—Incorporate information about the fault tolerance mechanisms in place, such as redundancy and failover capabilities.

Price and cost metrics can include, as examples: (i) Cost per Unit—Include the cost associated with each storage class or device per unit (e.g., cost per GB); and (ii) Pricing models—Consider different pricing models, such as pay-as-you-go, reserved instances, or any other pricing variations.

Durability and reliability can include, as examples: (i) Data Durability—Capture metrics related to the durability of stored data, such as the likelihood of data loss or corruption; (ii) Reliability Score—Extend the reliability score to include factors beyond just hardware reliability. It could encompass aspects like data redundancy and recovery mechanisms.

Environmental impact and sustainability metrics can include, as examples, green computing metrics related to environmental impact of storage operations, such as energy consumption, and sustainability considerations.

Aspects described herein differ from other approaches for storage volume provisioning. Some conventional, albeit non-optimal, techniques include:
Selecting the cloud storage volume randomly from the available storage volumes at a given time. The random selection may be undesirable where the selection does not meet application requirements that require, for instance better bandwidth or lower latency;
Selecting based on utilization of storage space in a particular storage node, in which storage volumes are allocated to a given storage group until that group reaches a threshold value of utilization, then subsequent allocations move to a next storage group;
Selecting based on counters associated to particular storage groups, where the group's counter is used to determine the number of times a storage volume has been allocated to that storage group; and
Selecting based on a round-robin mechanism that determines storage capacity space and, based on a threshold value for storage node availability, allocates the storage volume to that group.

In each of the mechanisms mentioned above, storage characterizations, such as throughput, latency, number of IO operation requests, and network request/responses as examples, are not considered but might impact application performance and efficiency. As storage space grows in cloud storage facilities and distributed cloud storage environments, there is a need for optimally allocating storage volumes for storing client data. Accordingly, aspects described herein perform adaptive provisioning of storage volumes in a cloud storage environment, in which the adaptive provisioning learns based on application requirements and historical data analyses to classify storage devices. Aspects leverage a vector database, built from historical data, and semantic searching to perform similarity searching, with consideration for specific application requirements and optionally current workload.

The use of adaptive placement techniques, such as use of semantic searching against a vector database, can provide several benefits compared to traditional methods like those discussed above. These benefits include, but are not limited to:
Improved performance: By taking into account historical performance metrics and other storage device properties, including read/write operations per second, bandwidth, latency, usage with different workloads, and others, adaptive placement techniques described herein can ensure that new storage volumes are placed on devices with optimal characteristics for the specific workload and application requirements called-for. This can lead to faster response times and better overall performance.
Reduced costs: By optimizing volume placement based on historical performance metrics and other storage device properties, adaptive placement techniques can help reduce unnecessary spending on underutilized or inefficient storage devices. This can lead to cost savings over time, especially for businesses with large-scale cloud storage environments.
Increased scalability: Adaptive placement techniques allow for dynamic and flexible scaling of storage resources, making it easier to accommodate changing workloads and business needs. By analyzing historical data from the vector database and other sources, adaptive placement techniques can make informed decisions about where to place new storage volumes in the cloud storage environment.
Better resource allocation: By analyzing historical data from the vector database and other sources, adaptive placement techniques can make informed decisions about where to place new storage volumes in the cloud storage environment. This helps ensure that storage capacity is being used efficiently and effectively, reducing wasteful overprovisioning or underutilization of resources.
Improved visibility and control: Adaptive placement techniques provide detailed insights into storage usage patterns and performance metrics, allowing businesses to monitor and optimize their cloud storage environments more effectively. By using the vector database and other sources to track usage patterns and identify potential issues before they become problems, businesses can make informed decisions about how to allocate resources more effectively.
Automated decision-making: Adaptive placement techniques can automate volume placement decisions based on predefined rules and algorithms. This means that businesses can rely on adaptive placement techniques to make informed decisions about where to place new storage volumes in the cloud storage environment. Adaptive placement techniques can also help businesses save time and reduce errors compared to manual processes, as they automate decision-making based on predefined rules and algorithms.

Overall, adaptive placement techniques as described herein provide a range of benefits, including improved performance, reduced costs, increased scalability, better resource allocation, improved visibility and control, and automated decision-making, as examples.

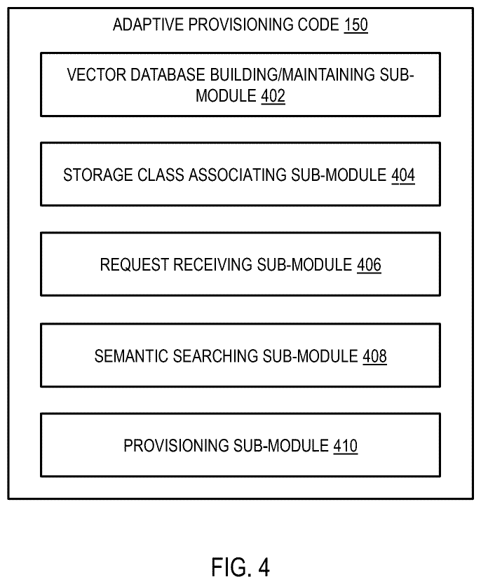

FIG. 4 depicts further details of an example adaptive provisioning code (e.g., adaptive provisioning code 150 of FIG. 1) to incorporate and/or use aspects described herein. In one or more aspects, adaptive provisioning code 150 includes, in one example, various sub-modules to be used to perform adaptive provisioning as described herein. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 4, adaptive provisioning code 150 includes vector database building/maintaining sub-module 402 for, e.g., building and maintaining a vector database having properties of storage devices of a cloud environment, storage class associating sub-module 404 for, e.g., associating storage devices with storage classes using the properties of the storage devices, request receiving sub-module 406 for, e.g., receiving a request for provisioning a storage volume to support a workload, semantic searching sub-module 408 for, e.g., performing a semantic search on the vector database and determining, based on the semantic search, a storage class for the requested storage volume, and provisioning sub-module 410 for, e.g., provisioning the storage volume on a storage device of the storage devices.

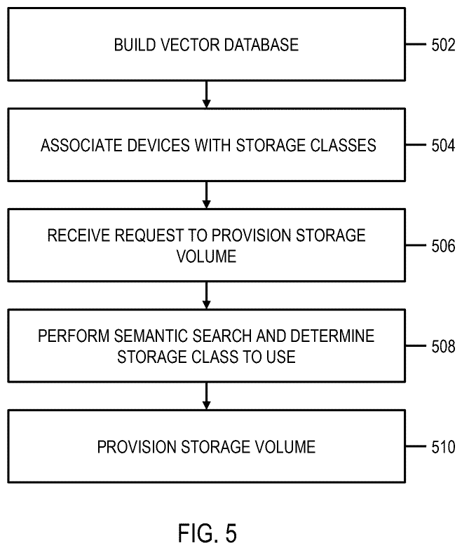

FIG. 5 depicts an example process for adaptive provisioning of a storage volume in a cloud environment, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 5 are part of a module, such as module 150. In other examples, the code may be included in one or more modules and/or in one or more sub-modules of the one or more modules. Various options are available.

The process of FIG. 5 includes building (502) a vector database having properties of storage devices of a cloud environment. In embodiments, the properties of the storage devices include historic performance metrics of the storage devices for different workload types. For instance, the historic performance metrics can include metrics related to input/output per unit of time (IOPS), bandwidth, latency, and/or response times of the storage devices, as examples. In some embodiments, the properties of the storage devices further include metrics of storage device availability, reliability, durability, environmental impact, and/or sustainability. The process can further include maintaining this vector database. For instance, maintaining could include performing a refresh of a model for building the vector database. A decision to perform the refresh can be based on (i) changes in characteristics of workloads supported by the storage devices, the characteristics including types or number of applications, usage patterns, or performance requirements, as examples, (ii) changes in storage infrastructure, the changes in storage infrastructure including introduction of a new storage class, removal of storage class of the storage classes, or changes in network configuration of the cloud environment, as examples, and/or (iii) lapse of a time interval for updating the vector database.

Continuing with FIG. 5, the process associates (504) the storage devices with storage classes using the properties of the storage devices. Each storage device of the storage devices is associated with a storage class of the storage classes. The process also receives (506) a request for provisioning a storage volume to support a workload, where the request indicates application requirements associated with servicing the workload. In embodiments, the application requirements include requirements for IOPS, bandwidth, latency, and/or response times for the workload.

The process then performs (508) a semantic search on the vector database and determines, based on the semantic search, a storage class for the requested storage volume. In embodiments, the performance of the semantic search uses the indicated application requirements to identify candidate storage classes for the requested storage volume by identifying vectors of the vector database that semantically match to the application requirements.

For instance, the semantic search can include an embedding-based semantic search that represents vectors of the vector database as embeddings in a continuous vector space, where the performance of the semantic search identifies one or more vectors, of the vector database, embedded in the continuous vector space nearest a vector built based on the indicated application requirements. Alternatively, the semantic search can include a graph-based semantic search that builds a graph with nodes representing vectors of the vector database and edges connecting nodes that are among k-nearest neighbors based on a distance metric, where the performance of the semantic search identifies one or more nodes, of the graph, with edges connecting to a node, of the graph, built based on the indicated application requirements.

In examples, determining the storage class includes determining whether the indicated application requirements match to a storage class of the storage classes. If there is such a match, then that identifies the storage class and therefore appropriate device(s) on which to provision the volume. Alternatively, based on determining that the indicated application requirements fail to match to any storage class of the storage classes, the storage class is determined based on sematic similarity between the indicated application requirements and a list of candidate storage classes, provided by the sematic searching, ranked by their semantic similarity to the indicated application requirements and storage system pressure.

Continuing with FIG. 5 after the storage class is determined, the process provisions (510) the storage volume on a storage device of the storage devices, of the storage devices, associated with the determined storage class for the requested storage volume.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
building a vector database having properties of storage devices of a cloud environment;
associating the storage devices with storage classes using the properties of the storage devices, each storage device of the storage devices being associated with a storage class of the storage classes;
receiving a request for provisioning a storage volume to support a workload, wherein the request indicates application requirements associated with servicing the workload;
performing a semantic search on the vector database and determining, based on the semantic search, a storage class for the requested storage volume; and
provisioning the storage volume on a storage device, of the storage devices, associated with the determined storage class for the requested storage volume.

2. The method of claim 1, wherein the properties of the storage devices comprise historic performance metrics of the storage devices for different workload types, the historic performance metrics comprising metrics related to input/output per unit of time (IOPS), bandwidth, latency, and response times of the storage devices.

3. The method of claim 2, wherein the properties of the storage devices further comprise metrics of storage device availability, reliability, durability, environmental impact, or sustainability.

4. The method of claim 2, wherein the application requirements comprise requirements for IOPS, bandwidth, latency, and response times for the workload.

5. The method of claim 1, wherein the performing the semantic search uses the indicated application requirements to identify candidate storage classes for the requested storage volume by identifying vectors of the vector database that semantically match to the application requirements.

6. The method of claim 5, wherein the semantic search comprises an embedding-based semantic search that represents vectors of the vector database as embeddings in a continuous vector space, and wherein the performing the semantic search identifies one or more vectors, of the vector database, embedded in the continuous vector space nearest a vector built based on the indicated application requirements.

7. The method of claim 5, wherein the semantic search comprises a graph-based semantic search that builds a graph with nodes representing vectors of the vector database and edges connecting nodes that are among k-nearest neighbors based on a distance metric, wherein the performing the semantic search identifies one or more nodes, of the graph, with edges connecting to a node, of the graph, built based on the indicated application requirements.

8. The method of claim 1, further comprising maintaining the vector database, the maintaining comprising performing a refresh of a model for building the vector database, the performing the refresh being based on:
changes in characteristics of workloads supported by the storage devices, the characteristics comprising types or number of applications, usage patterns, or performance requirements;
changes in storage infrastructure, the changes in storage infrastructure comprising introduction of a new storage class, removal of storage class of the storage classes, or changes in network configuration of the cloud environment; or
lapse of a time interval for updating the vector database.

9. The method of claim 1, wherein the determining the storage class comprises:
determining whether the indicated application requirements match to a storage class of the storage classes; and
based on determining that the indicated application requirements fail to match to any storage class of the storage classes, determining the storage class based on sematic similarity between the indicated application requirements and a list of candidate storage classes, provided by the sematic searching, ranked by their semantic similarity to the indicated application requirements.

10. A computer system comprising:
at least one computing device;
a set of one or more computer readable storage media; and
program instructions, collectively stored in the set of one or more computer readable storage media, for causing the at least one computing device to perform computer operations including:
building a vector database having properties of storage devices of a cloud environment;
associating the storage devices with storage classes using the properties of the storage devices, each storage device of the storage devices being associated with a storage class of the storage classes;
receiving a request for provisioning a storage volume to support a workload, wherein the request indicates application requirements associated with servicing the workload;
performing a semantic search on the vector database and determining, based on the semantic search, a storage class for the requested storage volume; and
provisioning the storage volume on a storage device, of the storage devices, associated with the determined storage class for the requested storage volume.

11. The computer system of claim 10, wherein the properties of the storage devices comprise historic performance metrics of the storage devices for different workload types, the historic performance metrics comprising metrics related to input/output per unit of time (IOPS), bandwidth, latency, and response times of the storage devices.

12. The computer system of claim 11, wherein the properties of the storage devices further comprise metrics of storage device availability, reliability, durability, environmental impact, or sustainability.

13. The computer system of claim 11, wherein the application requirements comprise requirements for IOPS, bandwidth, latency, and response times for the workload.

14. The computer system of claim 10, wherein the performing the semantic search uses the indicated application requirements to identify candidate storage classes for the requested storage volume by identifying vectors of the vector database that semantically match to the application requirements.

15. The computer system of claim 10, wherein the computer operations further include maintaining the vector database, the maintaining comprising performing a refresh of a model for building the vector database, the performing the refresh being based on:
changes in characteristics of workloads supported by the storage devices, the characteristics comprising types or number of applications, usage patterns, or performance requirements;
changes in storage infrastructure, the changes in storage infrastructure comprising introduction of a new storage class, removal of storage class of the storage classes, or changes in network configuration of the cloud environment; or lapse of a time interval for updating the vector database.

16. A computer program product comprising:
a set of one or more computer readable storage media; and
program instructions, collectively stored in the set of one or more computer readable storage media, for causing at least one computing device to perform computer operations including:
building a vector database having properties of storage devices of a cloud environment;
associating the storage devices with storage classes using the properties of the storage devices, each storage device of the storage devices being associated with a storage class of the storage classes;
receiving a request for provisioning a storage volume to support a workload, wherein the request indicates application requirements associated with servicing the workload;
performing a semantic search on the vector database and determining, based on the semantic search, a storage class for the requested storage volume; and
provisioning the storage volume on a storage device, of the storage devices, associated with the determined storage class for the requested storage volume.

17. The computer program product of claim 16, wherein the properties of the storage devices comprise historic performance metrics of the storage devices for different workload types, the historic performance metrics comprising metrics related to input/output per unit of time (IOPS), bandwidth, latency, and response times of the storage devices.

18. The computer program product of claim 17, wherein the properties of the storage devices further comprise metrics of storage device availability, reliability, durability, environmental impact, or sustainability.

19. The computer program product of claim 16, wherein the performing the semantic search uses the indicated application requirements to identify candidate storage classes for the requested storage volume by identifying vectors of the vector database that semantically match to the application requirements.

20. The computer program product of claim 16, wherein the computer operations further include maintaining the vector database, the maintaining comprising performing a refresh of a model for building the vector database, the performing the refresh being based on:
changes in characteristics of workloads supported by the storage devices, the characteristics comprising types or number of applications, usage patterns, or performance requirements;
changes in storage infrastructure, the changes in storage infrastructure comprising introduction of a new storage class, removal of storage class of the storage classes, or changes in network configuration of the cloud environment; or
lapse of a time interval for updating the vector database.
